(19) United States
(12) Patent Application Publication
(10) Pub. No.: US 2020/0248461 A1
(43) Pub. Date: Aug. 6, 2020

(54) ADHESIVE MAT FOR GLUING A TILE TO A WALL

(71) Applicants: Carsten SCHWIDOP, Lübbecke (DE); HYDROPHON KUNSTSTOFFTECHNIK GMBH, 57399 Kirchhundem (DE)

(72) Inventor: Thomas Hille, Kirchhundem (DE)

(73) Assignee: HYDROPHON KUNSTSTOFFTECHNIK GMBH, 57399 Kirchhundem (DE)

(21) Appl. No.: 16/637,173

(22) PCT Filed: Jul. 18, 2018
(86) PCT No.: PCT/EP2018/069522

§ 371 Date: Feb. 6, 2020

(30) Foreign Application Priority Data
Aug. 11, 2017 (DE) 10 2017 118 315.9

(51) Int. Cl. E04F 13/08; C09J 7/10; C09J 7/26

(52) U.S. Cl. CPC E04F 13/0887; E04F 15/02155; C09J 7/26; C09J 7/10

(57) ABSTRACT

An adhesive mat for gluing a the onto a well includes a plate-side adhesive layer for connection with the tile by a material union and a wall-side adhesive layer for gluing onto the well. In this way, tiles can be handled in a clean and dry manner. The adhesive mat may already be connected to a tile at the manufacturer's end to thereby form a tile unit. The adhesive mat can have at least one overhang over the border of the tile, such that several such tile units can be arranged in a grid pattern with the adhesive mats overlapping.

The invention relates to an adhesive mat for gluing a covering panel such as, for example, a the to a wall, a tile unit and a wall structure with such an adhesive mat, as well as to a method for attaching a covering panel such as, for example, a the to a wall.

Tiles are conventionally laid in “wet bed process” on the walls of interior rooms, onto floors or outdoors. A so-called the adhesive on mineral base or plastic base is initially mixed, which is then attached in viscous state between the tile and the wall and holds the tile on the wall after undergoing a hardening period. In the sanitary area, especially in wet cells, such as a bathroom, a water vapor barrier is normally provided between the tiles and the wall. In this regard, it is known from EP 2 584 113 A2 to adhere a sealing sheet with a water-impermeable plastic carrier layer to the wall across its entire surface, with the sealing sheet carrying on the room side a non-woven fabric to which a conventional the adhesive can adhere.

Against this background, it was an object of the present invention to provide means for alternative or simpler processing of covering panels or tiles.

This object is attained by an adhesive mat according to claim 1, by a the unit according to claim 6, by a wall structure according to claim 9, and by a method according to claim 13. Advantageous configurations are set forth in the subclaims.

According to a first aspect, the invention accordingly relates to an adhesive mat for gluing a covering panel such as, for example, a the to a wall, which adhesive mat includes the following components:
A panel-side first adhesive layer for connection of the adhesive mat to the wall side of the covering panel or tile by a material union.
A wall-side adhesive layer for gluing to the wall.

The term “covering panel” is generally understood to relate here and in the following to a panel-shaped article which is used as a component in buildings, in vehicles, on furniture or other objects, with the item generally being arranged on a visible surface. The material of a covering panel can basically be any material. In particular, a ceramic material, but also glass, plastic, aluminum or another metal, wood or the like, finds application. Furthermore, typically several (similar or different) covering panels are arranged in a grid or pattern, with the covering panels then oftentimes being referred to as “tiles”, in particular when made of a ceramic material. In the following, the terms “covering panel” and “tile” are essentially used synonymously, whereby the term “the” should not only be understood in a narrow, standardized sense.

As the term “mat” indicates, the adhesive mat is typically a flat, flexible structure which may assume the shape of (square or rectangular) panels or (elongated) sheets. Furthermore, the term “wall” denotes in particular a vertical building wall in the narrower sense. The adhesive mat must therefore also be suitable for being able to hold the weight of covering panels/tiles on such a vertical wall lastingly and without movements. In addition, the term “wall” relates however also generally here to all subsurfaces to which covering panels/tiles should be attached, i.e. also for floors, the surface of objects like furniture for example, or the like.

Although the mentioned adhesive layers are typically elastic (in particular permanently elastic) and flexible, they are, when viewed physically, “solid” in a physical state, i.e. they exhibit in the relevant time periods of a few decades no recognizable flow properties. Furthermore, the adhesive layers are typically permanently adhesive, i.e. the adhesiveness is not limited to a relatively short time period in which chemical reactions take place (crosslinking) and processing must take place. There are therefore normally no waiting times for a setting of the adhesive layers, when the adhesive mat is processed. The panel-side adhesive layer can, optionally, be connected by a material union to the tile using special processes such as vulcanization. Such processes are then preferably carried out at the manufacturer's end during production of the tile.

The adhesive mat according to the invention has the advantage that it enables “dry” processing of files. This means that there is no need to mix and process labor-intensively chemicals that pollute and possibly pose a health hazard. Instead, tiling of a room is reduced to a clean, dry gluing process.

The described adhesive mat can be refined in various ways. For example, it can include a carrier layer which is arranged between the panel-side and the wall-side adhesive layer. Such a carrier layer can, for example, provide a required mechanical stability and/or ensure a desired thickness of the adhesive mat. The carrier layer can preferably also be impermeable to water so as to assume the function of a water vapor barrier in the area of wet cells for example.

According to a preferred refinement, the aforementioned carrier layer includes or is made of plastic foam. In this case, good workability can be achieved as a result of the flexibility of the plastic foam, so that the adhesive mat is able to conform well, for example, to unevenness in the subsurface. The plastic foam may in particular involve one as described in WO 2016/128170 A1. The plastic foam can in particular be closed cell and/or be physically cross-linked and/or contain polyolefin, polyethylene, polypropylene, polyurethane, silicone, cellular rubber, acrylic foam, and/or butyl and/or have an elongation at break of over 300%.

The thickness of the carrier layer, in particular a carrier layer of plastic foam, amounts advantageously to more than approx. 0.1 mm or more than one of the dimensions listed below: approx. 0.2 mm, approx. 0.3 mm, approx. 0.4 mm, approx. 0.5 mm, approx. 0.6 mm, approx. 0.7 mm, approx. 0.8 mm, approx. 0.9 mm, approx. 1.0 mm, approx. 1.1 mm, approx. 1.2 mm, approx. 1.3 mm, approx. 1.4 mm, approx. 1.5 mm, approx. 1.6 mm, approx. 1.7 mm, approx. 1.8 mm, approx. 1.9 mm, approx. 2.0 mm, approx. 3 mm, approx. 4 mm, approx. 5 mm, approx. 6 mm, approx. 7 mm, approx. 8 mm, approx. 9 mm, approx. 10 mm. Advantageously, the thickness of the carrier layer has one of the afore-listed dimensions with a tolerance of approx. ±30%.

In particular, one of the surfaces of the plastic foam may undergo a special treatment, for example a treatment which increases the surface tension, such as a corona treatment. As usual, the surface tension is defined as the work (Nm) that has to be expended to increase the surface (m²) of a material by one unit (measured in the unit N/m or dyn/cm=0.001 N/m). The surface tension of the foam is preferably increased to values of more than 30 dyn/cm, particularly preferably to approx. 40 dyn/cm or more. A surface treated in this way results in a good connection with the applied adhesive layer. In particular, both surfaces of the plastic foam can be treated, i.e. facing the panel-side and on the wall-side adhesive layer. The adhesive tensile strength of the adhesive mat is preferably at 0.2 N/mm² or more (determined in accordance with the budding authority approval for sheet-like sealing materials from (P)/PG-AIV-B or DIN EN 1348).

Furthermore, the plastic foam preferably includes no substances that lead to outgassing and no plasticizers.

The panel-side and/or the wall-side adhesive layer should be selected to conform to the subsurface on which they are to be glued. Optionally, both adhesive layers are made from the same adhesive. The adhesive layers may, in particular, contain or be made of at least one of the following materials: butyl, synthetic rubber, acrylic foam, hot melt, cross-linked or non-cross-linked acrylate, UV-cross-linked acrylate adhesive and/or an adhesive dispersion.

At least one of the adhesive layers of the adhesive mat is preferably covered with a detachable protective film so that it does not inadvertently stick to other objects before being processed.

The protective film involves preferably a tear-resistant protective film so that it does not tear when removed from the adhesive layer. The latter would be a hindrance when attaching large covering panels/tiles in particular.

The tear resistance of the protective film can, in particular, be at least of such magnitude that a 10 cm wide and 100 cm long strip thereof lastingly withstands without tearing a tensile force acting in longitudinal direction of more than approx. 3 N (Newton), more than approx. 6 N, more than approx. 10 N, more than approx. 30 N, more than approx. 60 N, more than approx. 100 N, more than approx. 300 N, more than approx. 600 N, more than approx. 1000 N, more than approx. 5000 N, or even more than approx. 10000 N (i.e., when the two 100 cm distant ends of a 10 cm wide strip are pulled with opposing forces by the magnitude mentioned, the protective film does not tear; an elastic or plastic change in length is permitted). An alternative quantification of the tear resistance can be established using the parameter “tensile strength”, which in materials science designates the maximum tensile stress that can occur in a material. That being said, the tear resistance may also be characterized in that the protective film according to the invention has in longitudinal direction a (medium) tensile strength of (each at least) approx. 0.2 N/mm², approx. 0.4 N/mm², approx. 0.6 N/mm², approx. 2 N/mm², approx. 4 N/mm², approx. 6 N/mm², approx. 20 N/mm², approx. 40 N/mm², approx. 70 N/mm², 300 N/mm², approx. 700 N/mm², or at least approx. 1000 N/mm². The desired tear resistance can be realized, for example, by a correspondingly high thickness of the film. In addition or as an alternative, the protective film can be reinforced, for example by embedded fibers, in order to realize the tear resistance.

Furthermore, it is preferred when the protective film has on both sides a non-(permanently) adhesive surface that can be peeled off (from the adhesive layer). Such a peel-off capability can be realized, for example, through siliconizing the surfaces. The peel-off capability on both sides has the advantage that there is no inadvertent gluing between the outer surface of the protective film which has already been peeled off and the adhesive layer during assembly.

According to a second aspect, the invention relates to a unit, hereinafter referred to as “tile unit” without restricting generality, which includes a covering panel, such as, for example, a tile, and arranged thereon on a wall side an adhesive mat according to one of the afore-described embodiments. Such a tile unit is typically factory-made already, i.e. finished during manufacture of the covering panel/tile. On site, there is therefore only a need to attach the tile unit with the wall-side adhesive layer to a wall to be tiled.

Advantageously, the adhesive mats of the tile unit form during transport of the tile units intermediate buffers, which can prevent damage to the fragile tiles.

Further advantages involve the possible integration of a seal (in particular when the adhesive mat contains a water-impermeable carrier layer) and/or a thermal and acoustic insulation (in particular when the adhesive mat contains a plastic foam).

The tile should be as flat as possible so that the adhesive mat adhering to the covering panel/tile comes into full-surface contact with a wall and thus creates a maximum adhesive effect. Preferably, the deviation of the wall side of the tile from an exactly flat surface is thus less than ten percent, less than five percent, less than three percent, less than two percent, or particularly preferably less than one percent of the tile thickness. With a typical tile thickness of eight millimeters, the absolute deviation is therefore preferably less than 800 μm to less than 80 μm.

The adhesive mat can only partially cover the wall side of the covering panel/tile, for example in a border region. Preferably, the adhesive mat covers, however, the entire wall side of the covering panel/tile. Then, a full-surface gluing (essentially) without voids between the covering panel/tile and the wall is possible. This improves the thermal insulation, prevents the formation of mold (no shift of the dew point in a void), and prevents the risk of breakage of the covering panel/tile when exposed to stress concentrated above a void.

According to a further embodiment, the adhesive mat has an overhang on at least one border of the tile. Such an overhang can be used to make connections to adjacent objects, usually adjacent tiles. When the adhesive mat assumes the function of a water vapor barrier, for example, then an overlapping gluing of adhesive mats of adjacent tile units can ensure the presence of a water vapor barrier for an entire wall. In order to avoid any overlap gaps, the overhangs of the adhesive mats are appropriately shaped, so that an arrangement of several the units in a grid creates a full overlap of the adhesive mats without linear and/or spot-shaped joints.

Optionally, the adhesive mats can have a smaller thickness in the areas in which they overlap adjacent adhesive mats in the described implementation. In particular, its thickness can be selected such that the overlap zone has approximately the same total thickness as the simple adhesive mat in the non-overlapping region. In this way, unevenness as a result of doubling or tripling of material can be avoided.

According to a third aspect, the invention relates to a wall structure which includes the following components:
A wall, with this term encompassing, as explained, not only vertical walls, but also subsurfaces in general.
An adhesive mat according to one of the afore-described embodiments.
A covering panel such as, for example, a tile.

While the covering panel/tile in the wall structure is normally arranged directly on the panel-side adhesive layer of the adhesive mat, additional components can optionally be located between wall and adhesive mat. For example, a sealing sheet made of a water-impermeable material can be arranged between wall and adhesive mat. Examples of such sealing sheets can be found in EP 2 584 113 A2 and WO 2016/128170 A1, which are fully incorporated into the present application. When using such a sealing sheet, it is no longer necessary for the adhesive mat to be water-impermeable or to form a water vapor barrier.

According to a preferred embodiment, the wall structure contains at least two covering panels/tiles which are arranged in abutting relationship. Thus, there is no gap in the form of a joint between the covering panels/tiles. All covering panels/tiles of the wall structure are preferably arranged in this manner without joints or with “press joints”. Such a structure is in particular possible as a result of a “floating” securement of the covering panels/tiles on the wall, when the adhesive mat contains a permanently elastic material, for example in the form of a plastic foam. Then, the transfer of (setting) movements from the wall to the covering panels/tiles can be prevented, which require the presence of expansion joints in conventional systems.

Furthermore, the wall structure is advantageously such that there is essentially no void between the covering panel/tile and the wall.

According to a fourth aspect, the invention relates to a method for attaching a covering panel/tile to a wall, which is characterized by the following steps:
Attachment of an adhesive mat according to one of the afore-described embodiments onto a covering panel/tile or on the wall.
Gluing the covering panel/tile to the wall.

According to the method, an adhesive mat can thus first be attached to the wall, whereupon the covering panels/tiles are then glued onto the panel-side adhesive layer of the mat. Alternatively, the adhesive mat can first be attached to the covering panel/tile, which may already been done at the manufacturer's end, and the thus equipped covering panel/tile is then glued to the wall.

In order to facilitate positioning and aligning of the covering panels/tiles during gluing onto the wall, a temporary release agent may, optionally, be used between the active adhesive layer and the wall or tile, for example by moistening with water. The full adhesive force of the adhesive is established, only when the release agent has disappeared through manipulation, evaporation, diffusion or decomposition.

The method preferably involves full-surface gluing, i.e. essentially without voids between covering panels/tiles and wall.

In accordance with another embodiment of the method, a sealing strip is arranged between two covering panels and the wall in such a way that it covers the boundary line between the covering panels. In this way, a tightness of the entire surface can be ensured even when, for example, using tile units having an adhesive mat which does not extend beyond the border of the covering panels/tiles. In such a case, there are butt lines between the adhesive mats, at which tightness may not be maintained. This however is prevented by the sealing strip which overlaps the butt line.

Exemplary embodiments of the invention will be explained in greater detail hereinafter with reference to the attached figures. It is shown in:

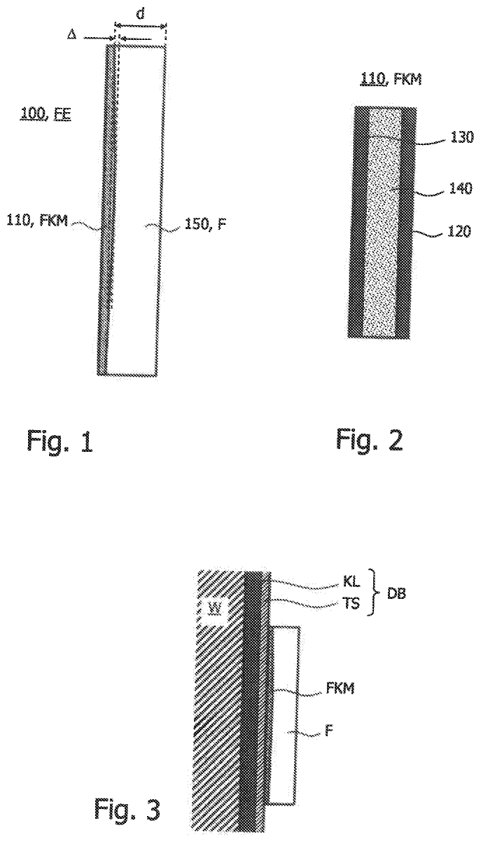

FIG. 1 a schematic cross section through a tile unit according to the invention with a the and an adhesive mat;

FIG. 2 a possible structure of the adhesive mat of FIG. 1;

FIG. 3 a possible wall structure when using the tile unit of FIG. 1 and a sealing sheet;

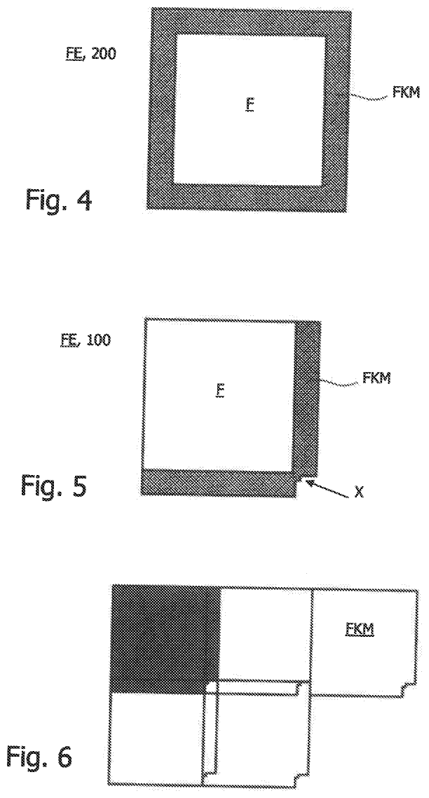

FIG. 4 a plan view of a tile unit with the adhesive mat having an overhang on all sides;

FIG. 5 a plan view of an alternative tile unit with an overhang on only two sides;

FIG. 6 the arrangement of several tile units according to FIG. 5 in a grid with gapless overlap of the adhesive mats;

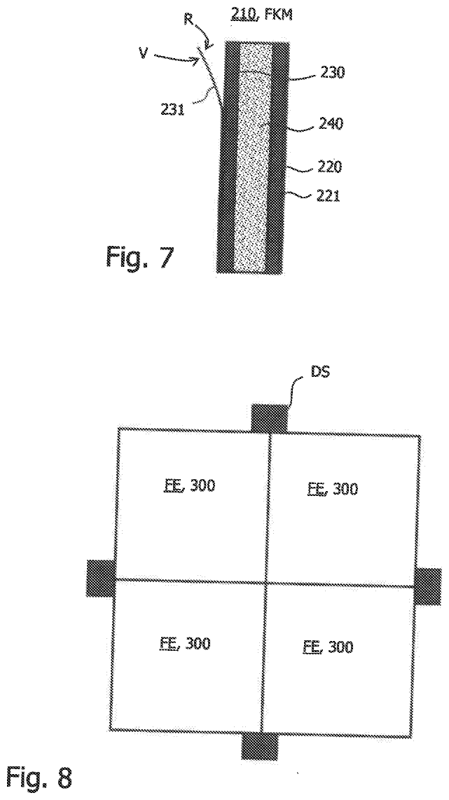

FIG. 7 a structure of an adhesive mat with protective films on both sides;

FIG. 8 a seamless wall structure with press joints.

FIG. 1 illustrates a schematic cross section, not to scale, of a tile unit 100 (generally also designated by the letter sign “FE”). The tile unit 100 is made of a conventional, for example ceramic, tile 150 (“F”) as a covering panel, and of a (tile) adhesive mat 110 (“FKM”) which is connected to the wall side of the tile by a material union. Such a connection can already be made in the factory after the tile has been produced. Optionally, however, the adhesive mat may also be produced at first as a separate unit and subsequently glued to the tile, for example on site at the construction site. It is important that the adhesive mat FKM has an adhesive layer on the wall side (left in FIG. 1) to enable the tile unit FE to be glued onto a vertical wall. This enables a particularly simple and clean processing of the tile units.

Furthermore, it is indicated in the figure that the wall-side surface of the the F can deviate from a geometrically exact flatness by a maximum dimension A. In the present case, however, this deviation should be less than approx. 5% of the tile thickness d, i.e. (Δ/d)≤0.05 (or even less). This ensures in this case that the adhesive mat can completely contact a wall.

The format of the tile unit FE can in particular be very large, for example a rectangle with an area of one to several square meters.

FIG. 2 shows also a schematic cross section, not to scale, of a possible structure of an adhesive mat FKM, for example the adhesive mat 110 used in FIG. 1. The FKM adhesive mat contains as essential components a panel-side adhesive layer 120 and a wall-side adhesive layer 130. In the illustrated exemplary embodiment, these two adhesive layers are on the opposite surfaces of a plastic foam layer 140. This can in particular be a plastic foam according to WO 2016/128170 A1.

In particular, the plastic foam layer 140 may be made of a physically cross-linked plastic foam having tile-side and wall-side surfaces which are corona-treated in order to attain a good connection to the respective adhesive layer 120, 130. The thickness of the plastic foam layer 140 is preferably between approx. 0.2 mm and 2 mm.

FIG. 3 shows a schematic cross section of a wall structure, as created by attaching the tile unit FE from FIG. 1 to a wall W. The tile unit with the tile F and the adhesive mat FKM is hereby not glued directly to the wall W (i.e. typically the interior plaster), though this would also be possible, but to a sealing sheet DB. This can involve, for example, a sealing sheet according to EP 2 584 113 A2 or WO 2016/128170 A1, which includes a water-impermeable carrier layer TS and a wall-side adhesive layer KL. The sealing sheet DB is firmly glued with the wall-side adhesive layer KL to the wall while exhibiting a surface toward the room for allowing adherence of the adhesive layer of the FKM adhesive mat.

FIG. 4 shows a plan view of the room side of a possible embodiment of a tile unit 200. This includes a rectangular the F and a likewise rectangular adhesive mat FKM, which has an overhang on all four borders of the tile. Adjacent tiles or tile units can be glued onto the overhang. In order to prevent the adhesive mat from lying upon the top of a tile, the respective overhanging borders may e.g. be folded away or trimmed away.

FIG. 5 shows an alternative embodiment of a tile unit 100, in which such a trimming away of overhangs has already been carried out on two adjacent borders of the tiles at the manufacturers end.

In this regard, FIG. 6 shows how several such tile units 100 can be arranged in a grid, with the adhesive mats FKM overlapping everywhere. There are therefore no butt lines or abutment points where water could penetrate. Care should be taken to the provision of a small overhang X on a tile corner, by means of which a spot-shaped passage without covering with adhesive mats is avoided.

In order to prevent excessive thicknesses as a result of material doubling or even tripling in the zones shown in FIG. 6, the adhesive mats can be made correspondingly thinner in these regions, so that the overall thickness has always the same value everywhere.

FIG. 7 shows by way of a cross section analogous to FIG. 2, an adhesive mat 210 (FKM), which likewise is made of a plastic foam layer 240 with adhesive layers 220, 230 applied on both sides. Furthermore, two protective films 221 and 231 are illustrated (one of which is partially detached), which cover the adhesive surfaces until processing. In particular, the protective films 231 on the wall-side adhesive layer 230 should hereby be tear-resistant so as to enable a removal thereof over a greater distance without tearing. This is important when, for example, a large the is glued to a wall, because when already being partially glued, there is not enough space behind the tile to remove a torn protective film if need be.

If necessary, the protective film 221, 231 can be divided into required pieces by scoring or cutting with a knife. Due to the relatively high thickness of the plastic foam layer 240 (for example approx. 0.8 mm) compared to a plastic film, the knife tip may even slightly penetrate into the layers 230, 240 lying under the protective film, without adversely affecting the impermeability of the FKM adhesive mats to water.

Furthermore, both the adhesive-side rear side R and the front side V of the protective film 231 are preferably non-adhesive or detachable (e.g. siliconized) so as to prevent interference with the assembly through inadvertent sticking of the front V upon the already exposed adhesive layer. For example, PET, HDPE or PP are suitable as materials for the protective films.

The panel-side protective film 221 may also be omitted when the adhesive mat FKM is glued directly to the tile at the manufacturer's end.

FIG. 8 shows four tile units 300 (FE) which (unlike the tile units 100 and 200 of FIGS. 4 and 5) do not have an adhesive mat FKM that protrudes at the border. So as to still maintain tightness along the boundary line between adjacent tiles, water-impermeable sealing strips DS are glued on and underlap the boundary lines, before the tile units 300 are mounted onto the wall. To avoid unevenness, the sealing strips DS are configured relatively thin, for example with a thickness between 0.1 mm and 0.5 mm.

It is hereby also apparent that the tile units 300 contact one another, i.e. they are attached to the wall without gaps or with press joints. This is possible because the plastic foam layer of the adhesive mat provides a floating support that decouples the wall and the tiles. The creation of shadow gaps is also possible.

In conclusion, it should be pointed out that in the above explanations the term “tile” is to be understood more generally in the sense of a “covering panel”. Such a covering panel can be used not only on building walls or floors, but also in or on vehicles, on furniture (e.g. kitchen fronts) or other objects. The covering panel may hereby be made entirely or partially of ceramic material such as earthenware, of glass, of plastic (PE, PP etc.), of metal (aluminum), of wood or the like.

What is claimed is:

1.-15. (canceled)

16. An adhesive mat for gluing a covering panel to a wall, said adhesive mat comprising:
a panel-side adhesive layer for connection to the covering panel by a material union; and
a wall-side adhesive layer for gluing to the wall.

17. The adhesive mat of claim 16, further comprising a carrier layer arranged between the panel-side adhesive layer and the wall-side adhesive layer.

18. The adhesive mat of claim 17, wherein the carrier layer is water-impermeable.

19. The adhesive mat of claim 17, wherein the carrier layer contains a plastic foam.

20. The adhesive mat of claim 16, wherein at least one of the panel-side adhesive layer and the wall-side adhesive layer contains or is made of at least one of the following adhesives: butyl, synthetic rubber, acrylic foam, hot melt, cross-linked or non-cross-linked acrylate, UV-cross-linked acrylate adhesive and/or an adhesive dispersion.

21. The adhesive mat of claim 16, further comprising a removable protective film configured to entirely or partially cover at least one of the panel-side adhesive layer and the wall-side adhesive layer.

22. The adhesive mat of claim 21, wherein the protective film is tear resistant and/or has a non-adhesive surface on both sides.

23. A tile unit, comprising:
a covering panel; and
an adhesive mat arranged on a wall side of the covering panel, said adhesive mat comprising a panel-side adhesive layer for connection to the covering panel by a material union, and a wall-side adhesive layer for gluing to the wall.

24. The tile unit of claim 23, wherein the covering panel is a tile.

25. The tile unit of claim 23, further comprising a carrier layer arranged between the panel-side adhesive layer and the wall-side adhesive layer, said carrier preferably being water-impermeable.

26. The tile unit of claim 25, wherein the carrier layer contains a plastic foam.

27. The tile unit of claim 23, wherein at least one of the panel-side adhesive layer and the wall-side adhesive layer contains or is made of at least one of the following adhesives: butyl, synthetic rubber, acrylic foam, hot melt, cross-linked or non-cross-linked acrylate, UV-cross-linked acrylate adhesive and/or an adhesive dispersion.

28. The tile unit of claim 23, wherein the adhesive mat includes a removable protective film configured to entirely or partially cover at least one of the panel-side adhesive layer and the wall-side adhesive layer, said protective film being preferably tear resistant and/or has a non-adhesive surface on both sides.

29. The tile unit of claim 23, wherein the covering panel has a wall side configured to deviate from a flat surface by less than 10%, preferably less than 5%, particularly preferably less than 2% of a panel thickness

30. The tile unit of claim 23, wherein the adhesive mat has an overhang on at least one border of the covering panel, so as to enable several of said tile units to be arranged in a grid with overlapping edges of the adhesive mats.

31. A wall structure, comprising:
a wall (W);
a covering panel; and
an adhesive mat arranged between the wall and the covering panel, said adhesive mat comprising a panel-side adhesive layer for connection to the covering panel by a material union, and a wall-side adhesive layer for gluing to the wall.

32. The wall structure of claim 31, further comprising a sealing sheet made of a water-impermeable material and being arranged between the wall and the adhesive mat.

33. The wall structure of claim 31, further comprising at least two of said covering panels arranged in abutting relationship.

34. The wall structure of claim 31, wherein the adhesive mat is arranged in the absence of any void between the covering panel and the wall.

35. A method for attaching a covering panel to a wall, said method comprising:
connecting a panel-side adhesive layer of an adhesive mat on the covering panel by a material union; and
gluing a wall side adhesive layer of the adhesive mat to the wall.

36. The method of claim 35, wherein the wall-side adhesive layer of the adhesive mat is in full-surface contact with the wall.

37. The method of claim 35, further comprising arranging a sealing strip between two covering panels and the wall such as to cover a boundary line between the covering panels.

38. The method of claim 35, further comprising arranging a, preferably water-impermeable, carrier layer arranged between the panel-side adhesive layer and the wall-side adhesive layer.

39. The method of claim 38, wherein the carrier layer contains a plastic foam.

40. The method of claim 35, wherein at least one of the panel-side adhesive layer and the wall-side adhesive layer contains or is made of at least one of the following adhesives: butyl, synthetic rubber, acrylic foam, hot melt, cross-linked or non-cross-linked acrylate, UV-cross-linked acrylate adhesive and/or an adhesive dispersion.

41. The method of claim 35, further comprising arranging a removable protective film such as to entirely or partially cover at least one of the panel-side adhesive layer and the wall-side adhesive layer, with the protective film being preferably tear resistant and/or having a non-adhesive surface on both sides.
